(19) United States
(12) Patent Application Publication
(10) Pub. No.: US 2005/0160012 A1
(43) Pub. Date: Jul. 21, 2005

(54) System and method for data display using variable field names

(76) Inventors: Diane Schechinger, Half Moon Bay, CA (US); David Fennell, Redwood City, CA (US)

Correspondence Address: DIANE SCHECHINGER, 441 ALAMEDA AVE, HALF MOON BAY, CA, 94019, US

(21) Appl. No.: 11/034,352

(22) Filed: Jan. 13, 2005

Related U.S. Application Data
(60) Provisional application No. 60/536,805, filed on Jan. 16, 2004.
(60) Provisional application No. 60/536,806, filed on Jan. 16, 2004.
(60) Provisional application No. 60/547,177, filed on Feb. 25, 2004.
(60) Provisional application No. 60/578,332, filed on Jun. 10, 2004.
(60) Provisional application No. 60/578,357, filed on Jun. 10, 2004.

(51) Int. Cl. G06F 17/60

(52) U.S. Cl. 705/26; 705/27; 707/3

(57) ABSTRACT

The use of computer technology and the internet to quickly locate, view, compare, and select marketable products or other data according to specific characteristics relevant to the intended use of the product. The growth of the internet has exceeded the capacity of existing technologies and business methods to allow business and consumer users to sort through a vast sea of data. The concept of Variable Field Names builds upon the simple concept of organizational hierarchy, and provides a system and method to enable the manipulation of data in a specific manner through the internet to the marketplace, in which all conceivable products, whatever their use or country of manufacture, can be located, reviewed, compared, and selected for purchase. The invention uses a hierarchy-based software system that will allow the computer user to search and find required data directly. The user will no longer waste time sifting through search results that are outside the needs of his current search.

### CROSS-REFERENCE TO RELATED APPLICATIONS

A. World.info PPA #2, “Schechinger/Fennell System and Method for Data Display Using Variable Field Headings,” filed Jan. 16, 2004, PTO Appl. No. 60/536,805 (This is the PPA for the present RPA Application for Variable Field Names. Note change in Title wording.)

B. World.info PPA#1, “Schechinger/Fennell System and Method for Categorization of Data,” filed Jul. 14, 2003, PTO Appl. No. 60/487.395

C. World.info RPA #1, “Fennell Hierarchy for Marketable Product Categorization,” filed Jul. 12, 2004, PTO application Ser. No. 10/889,374. (This is the RPA for PPA Appl. No. 60/487,395 above. Note change in Title wording.)

D. World.info PPA #3, “Schechinger/Fennell System and Method for Organization and Display of Data and Identification of Key Data for Comparison and Analysis,” filed Jan. 16, 2004, PTO Appl. No. 60/536,806

E. World.info RPA #3, “Schechinger/Fennell System and Method for Organization and Display of Data and Identification of Key Data for Comparison and Analysis,” filed Jan. 10, 2005, No PTO # on file.

F. World.info PPA #4, “Schechinger/Fennell System and Method for Filtering Search Results by Utilizing User-Selected Parametric Values from a Self-Defined Drop-Down List on a Website,” filed (mailed) Feb. 23, 2004, no PTO # on file

G. World.info PPA #5, “Schechinger/Fennell System and Method for filtering Data Search by Utilizing User Selected Checkboxes, filed Feb. 25, 2004, PTO Appl. No. 60/547,177

H. World.info PPA #6, “Schechinger/Fennell/Hirzel System and Method for Associating Unlimited Numbers of Parametric Names and Values to a Specific Product and the Ability to Select or Deselect for Viewing the Results on a Parametric Display Page,” filed Jun. 10, 2004, PTP Appl. No. 60/578,332

I. World.info PPA #7, “Schechinger/Fennell System and Method for Finding Specific Products that Meet Exact User Defined Requirements in Three Clicks.” Filed Jun. 10, 2004, PTO Appl. No. 60/578,357

### BACKGROUND OF THE INVENTION

1. Field of the Invention

This invention relates to, but is not limited to, the use of computer database and software technology and the internet to locate, view, compare, and select marketable products or other data.

2. Prior Art

Since the advent of the personal computer, the internet has truly become the “World-wide web,” with terminals in every nation linked to each other sharing information and transmitting data in quantities and at speeds undreamed of even a decade ago. The growth of the internet has exceeded the capacity of existing technologies and business methods to allow business and consumer users to access, compare, and sort items of a like kind in a comprehensible manner from this vast ocean of unorganized data.

Existing methods of filtering information from computer databases, commonly known as “search engines,” which can be found in websites such as “Google.com,” “Vehix.com,” “Globalspec.com,” and others, are either too nonspecific, or too restrictive in their approach, and do nothing meaningful to organize the countless reams of marketing data into an instantly usable and understandable format. Their displays are based on fixed field headings requiring a separate layout for each single product, wherein system complexity renders it is impossible to display large numbers of products for comparison. Using the current art, once the user has entered such a site, he is obliged to navigate, using the familiar “point-and-click” process, through a varying number of discrete steps, from the website's home page, through that site's unique system of organization. Eventually, he may find that product whose combination of features and attributes meets his needs, most frequently in a multitude of clicks. The user often gets lost in the complex site navigation unique to each website, having never found the products of interest. It is at best a laborious, inefficient process, yielding doubtful results.

### BACKGROUND OF THE INVENTION—OBJECTS AND ADVANTAGES

A. The hierarchy imposes simplicity and order on a wildly chaotic universe of disorganized and inaccessible data.

B. Given the establishment of a certain level of order by means of the hierarchical system of categorization proposed in IIA and IIB above, and the additional functional features described other PPAs IIC-IIH referenced in II above, products may thus be displayed as fields within this hierarchy. This method of display is of particular interest to Engineers, Buyers, and Purchasing Agents who wish to compare only the specific characteristic s of the products being considered that are relevant to the intended application of the product. It simplifies their search by allowing them to focus on the relevant specifications while bypassing those not germane to the application.

C. The use of software technology enabling variable field names “Key Parameters 1 Name”, “Key Parameters 2 Name”, “Key Parameters 3 Name”, “Key Parameters n Name . . . ” instead of the specific parameter name used in the current art, allows a universally adaptable search and display mechanism.

D. An important part of this patent is the generic quality of the parameter name, so that it is useable with many types of products. This patent is meant to include other generic field names for variable parameters.

E. Page layouts for the variable parameters consist of as many columns as are required, or as conveniently fit within the page width. Key variables or parameters may be grouped together in distinct layouts but within a single page. There is no limit to the number of single-page layouts that may be required to adequately describe the parameters of a given product.

F. By making the field heading a variable associated with products of same kind (apples to apples), parametric headings of interest can be determined and entered into the variable fields for those specific products or services.

G. The values for these parameters can be determined by the owner of the database and can be changed according to input from the end User. Alternately, the end User can select which parameters he wishes to view by changing the variable parametric name.

H. The system can be used over the internet and will be accessible to end-users who have computers with internet access. Installation of software at computer terminals will not be required.

I. All products from all vendors are similarly displayed. This allows small business enterprise to compete on an equal footing with large corporations, encouraging innovation throughout the marketplace.

J. The invention relates to the display of virtually any type of product or service in any industry, including but not limited to those of manufacturing and entertainment.

K. Further objects and advantages of the invention will become apparent from a consideration of the Figures and ensuing description.

### SUMMARY OF THE INVENTION: VARIABLE FIELD NAMES

The invention is a universally variable method of displaying products in a series of single-page layouts, by which the user can quickly refine his search to a short list of like products with similar parameters to be compared and contrasted. An important part of the patent is the generic quality of the parameter name, so that it is useable with many types of products. The use of software technology enabling variable field names “Key Parameters 1 Name”, “Key Parameters 2 Name”, “Key Parameters 3 Name”, “Key Parameters n Name . . . ” instead of the specific parameter name used in the current art, allows this universally adaptable search and display mechanism.

### FIGURES

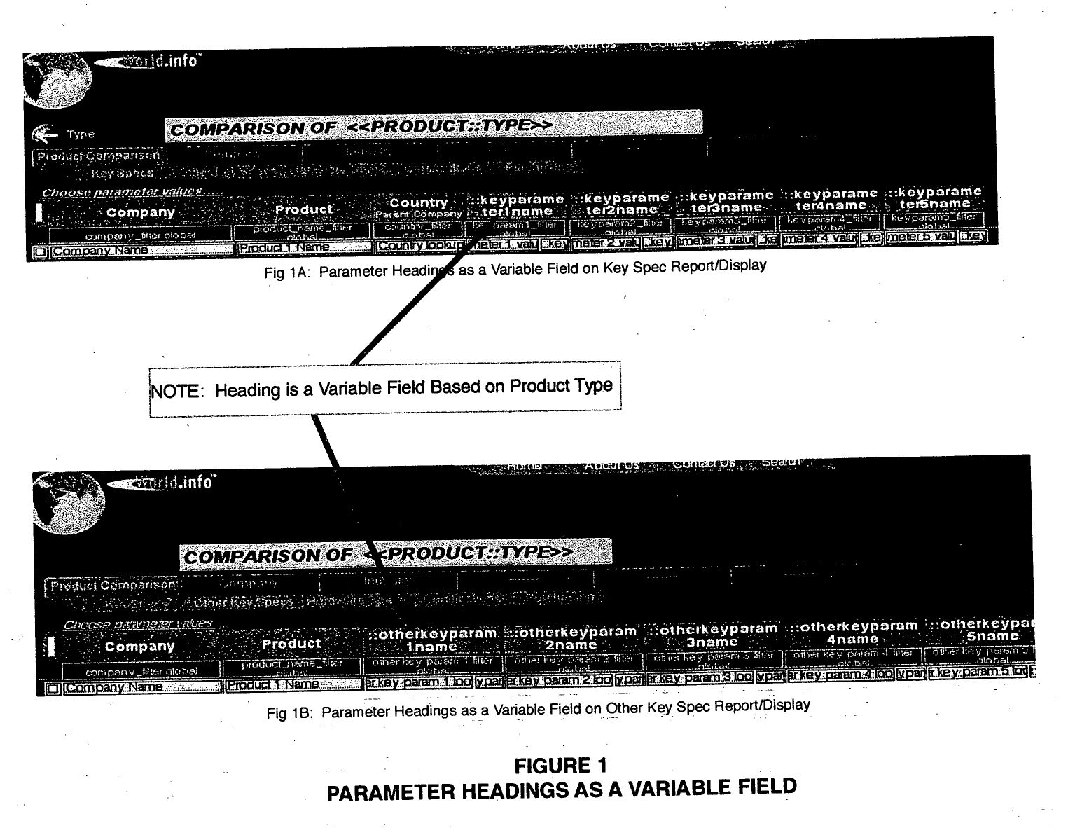

a. FIG. 1A: Parameter Headings as a Variable Field on “Key Spec” Page

b. FIG. 1B: Parameter Headings as a Variable Field on “Other Key Spec” Page

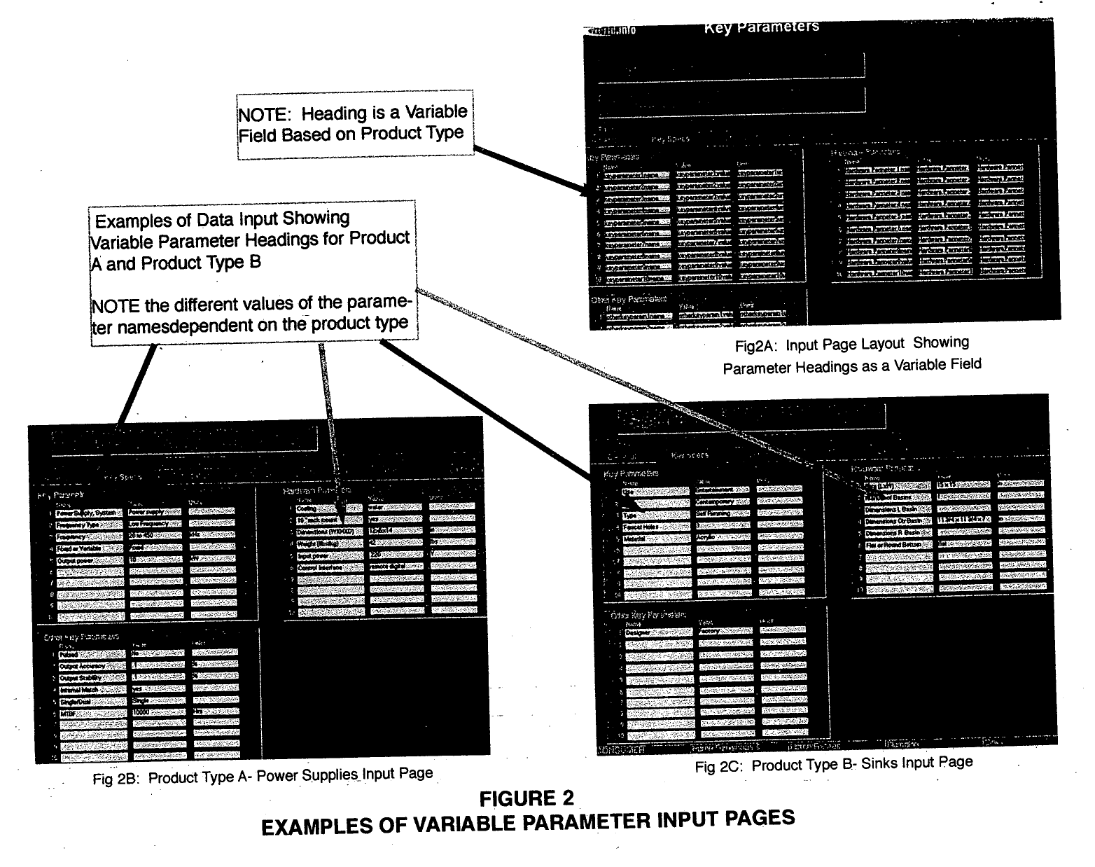

c. FIG. 2A: Input Page Layout Showing Parameter Headings as a Variable Field

d. FIG. 2B: Input Page for Product Type A

e. FIG. 2C: Input Page for Product Type B

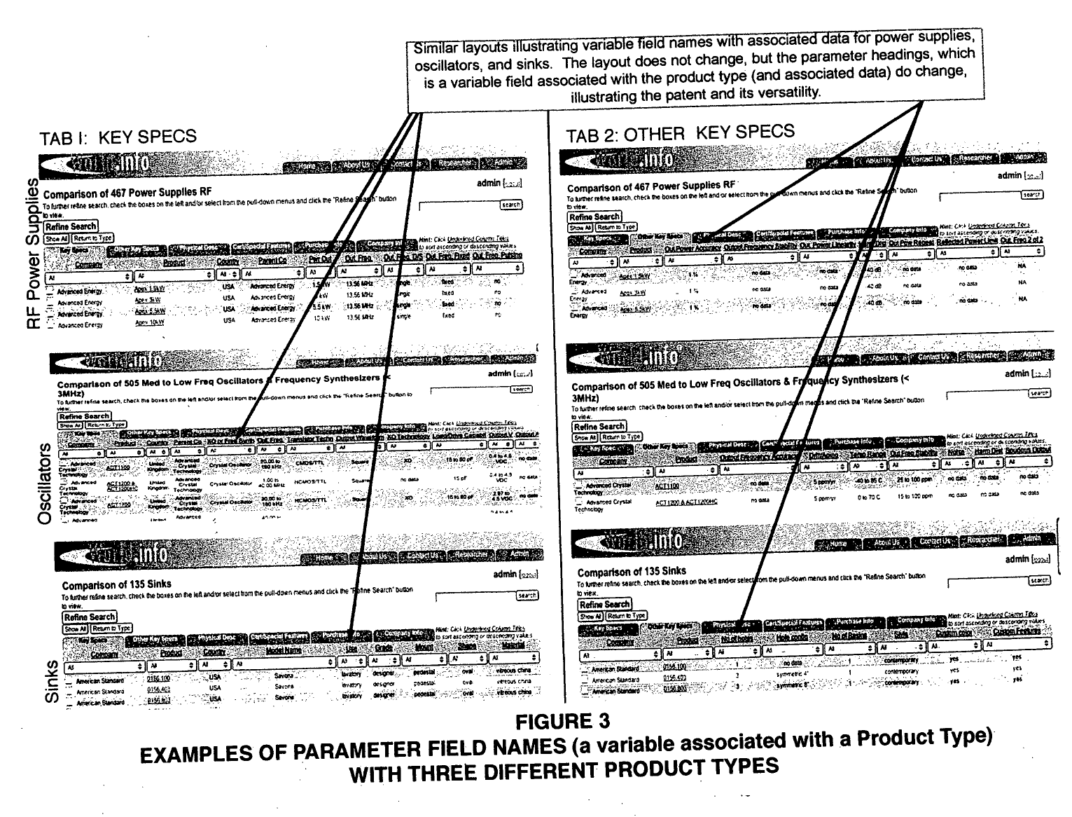

f. FIG. 3. Sample Display Page Illustrating One Single Layout Used on Two Pages (Tabs) for Three Products.

### DETAILED DESCRIPTION

The Variable Field Names are conceived to work within the Fennell Hierarchy (see IIB and IIC above) and applied in a specific manner through the internet to the marketplace, in which all conceivable products, whatever their use or country of manufacture, can be compared and contrasted with other products of a like kind, according to various parameters. When used in conjunction with the World.info website database and search process referenced above, it enables the user to immediately determine exactly which products of a given type will match the particular combination of parameters or attributes he is seeking.

This is accomplished by modifying the familiar “File, Record, Fixed Field Name” page layout for comparison to “File, Record, Variable Field Name 1,” where the field name is a variable field instead of a fixed field. This field name varies as a function of the product type as defined in our previous patent applications (IIB and IIC above). The user navigates through the hierarchy via the commonly used “point and click” computer technology until he has selected the product type of interest to him. Having arrived at the database of products specific to his needs, he then selects from among the fields of Key Parameters on display on the several pages available, the specific parametric values available in pulldown lists of all the values available within any given field. In this manner, by selecting a unique combination of specific parametric values and clicking on the “Refine Search” button, he is presented with the short list of all products within the database for that Product Type that match his unique requirements.

The present invention is the use of Variable Field Names within this type of search and display mechanism. For purposes of illustration, we have given the variable fields generic names, “Key Parameters 1 Name”, “Key Parameters 2 Name”, “Key Parameters 3 Name”, “Key Parameters n Name . . . ” (FIG. 1, 2) instead of the specific parameter name, as is done in the current art. An important part of the patent is the generic quality of the parameter name, so that it is useable with many types of products. This patent is intended to include other generic field names for variable parameters. The scope of the invention permits the creation of, or deletion of any number of fields within any given Product Type database, as future marketplace circumstances may require, and there is no limit to the potential number of Variable Fields or data records contained therein.

Product data is provided by the manufacturer or seller, in a data entry mechanism to be protected by a subsequent patent. Any new Product that is entered is immediately placed into its proper Product Type database(s) for ease of retrieval. Whenever a new product, service, or other item is entered into the database (FIG. 3, 4, 5), Key Parameter Names associated with that product are entered into the database by either manual, semiautomatic, or fully automatic method to be the subject of a future PTO application.

Different manufacturers of similar products may have differing ways of conceptualizing or displaying similar data; they may or may not have data available for a given Field; they may not wish to make certain data available. For these and other reasons, the data for any given products may be entered in any number of fields, not all of which need be visible on a display page. The data will exist within the database, as entered, but will only appear to the user if the Variable Field Name has been selected, from the realm of available Field Names for that database, to appear on the display page.

When one Field Name on the display page has been replaced by another, by either the user or the owner of the display page, the data for that Field will disappear, and the data associated with the new Field Name will appear in its place. In a similar manner, one Field may be moved from one page to another, to create a display layout configured by the user for his own convenience. Page layouts for the variable parameters consist of as many columns as are required, or as conveniently fit within the page width.

In this manner the available data may be manipulated into varying displays by the user or the owner of the database. Once each item is in the database and has the appropriate values entered under the Key Parameter Names assigned to it, retrieving only the Key Parameter Values which apply to that specific item, and thus “apples-to-apples” comparisons of parameters with other like products, becomes possible (FIG. 6).

The use of the term “product” as used in this patent application, while generally most useful in the marketplace arena to which the invention is primarily directed, is not intended to limit the scope of the invention to products only. The term “product” is construed to apply to any conceivable marketable item, object, service, performance, or idea. For example, its use includes, but is not limited to, such diverse items as the following: industrial or consumer products, fish ponds, county fairs, travel information, government contracts, international trade opportunities virtually any type of product, service, event, activity, or geographical location. The use of Variable Field Names and associated search mechanisms (referenced in the PPAs given in II above and others yet to be filed) may, within the scope of this patent application, be extended to other, noncommercial uses. The term “Parameter” as used in this application may be also variously defined as “asset,” “attribute,” “capacity,” “specification,” “value,” or “property.” This patent is intended to protect the business method of the use of the Variable Field Names as described herein. Specific algorithms and programming language to enable the processing of this method will be filed in subsequent patents applications. The Figures showing the current configuration of the World.info website layouts are purely illustrative of its capacities, and may be altered in configuration and appearance without departing from the spirit and scope of the current invention.

Note that the Variable Field Names, as used in conjunction with the Fennell Hierarchy works from both ends, in that it (a) enables the buyer (user) to refine his search to satisfy his owns specific needs, and (b) enables the seller to have his product easily found and readily available to the user's search. It “levels the playing field,” reducing or eliminating the need for blanket advertising in the hopes of attracting new customers who might otherwise be unaware of the existence of his business or his products.

Note that, while the Variable Field Names are conceived to work within the Fennell Hierarchy and associated Papas referenced in II above, the use of this invention is not restricted to these systems and methods, but may be broadly applied in other unspecified search and display mechanisms. The reader will note the extreme versatility of this method in displaying the parameters or attributes of any conceivable product, item, or service within an endlessly adaptable display utilizing variable field names or headings. The description contained within Section VII not to be construed as limiting the scope of the invention, but rather as an exemplification of one preferred embodiment thereof. Many other variations are possible, for example within existing or yet to be created search engines or websites of all kinds, commercial and noncommercial, incorporating the description or definitions of travel and entertainment opportunities, real estate, investment opportunities or consumer goods. Accordingly, the scope of the invention should not be determined by the embodiment listed above, but by the appended claims and their legal equivalents.

Unique systems and methods of navigation and display will be filed in subsequent patents.

1. A method of retrieving and displaying stored data of any kind, comprising:
a. a computer terminal connected to the internet,
b. a storage means for storing data on a digital or electronic storage medium,
c. an algorithmic logic circuit configured to prepare the storage medium to store the data,
d. an algorithmic logic circuit for locating the stored product and product specification data,
e. an algorithmic logic circuit by which the stored data may be associated with one or more field names or headings,
f. an algorithmic logic circuit for retrieval and display of located data in a user-manipulated spreadsheet display in a single- or multiple-page layout in which the fields as named or described by their various headings may be located at any place or no place within the spreadsheet display,
whereby specific data for a given item may be compared with like data for other items of a like kind, without the restrictions imposed by a fixed layout for fixed fields, by means of the infinitely variable field names or headings, each with its own associated data records, which may be displayed at any place within the layout.

2. The use of the said Variable Field Names as a business method as a means of locating, comparing, and selecting products for retrieval, review, and purchase.

3. A system for organizing, processing, locating, and comparing products appropriate to the user's specific needs comprising:
a. a computer terminal connected to the internet,
b. a storage means for storing data on a digital or electronic storage medium,
c. an algorithmic logic circuit configured to prepare the storage medium to store the data,
d. an algorithmic logic circuit for locating the stored product and product specification data,
e. an algorithmic logic circuit by which the stored data may be associated with one or more field names or headings,
f. an algorithmic logic circuit for retrieval and display of located data in a user-manipulated spreadsheet display layout in which the fields as named or described by their various headings may be located at any place or no within the spreadsheet display,
whereby specific data for a given product may be compared with like data for other products of a like kind, without the restrictions imposed by a fixed layout for fixed fields, by means of the infinitely variable field names or headings, each with its own associated data records, which may be displayed at any place within the layout.

4. The said data processing system of claim #3 further used as a business method as a means for enabling the user to retrieve, review and compare for purchase products of a like kind, by displaying only those specific characteristics of the products being considered that are relevant to the intended application of the product while bypassing those which are not germane to the application.

5. The said data processing system of claim #3 further used as a means of automatically changing parameter names and the associated data displayed according to product type, in conjunction with the selection by the User of a new product type within the display layout.

6. The said data processing system of claim #3 further used as a means of storing unlimited amounts of data and displaying it in unlimited variations of parameter fields applied to unlimited types of products.

7. The said data processing system of claim #3 further used as a component of internet navigation systems other than those covered by patents owned or claimed by World.info, as a means for enabling the user to retrieve, review and compare for purchase specific products of a like kind.

8. The said algorithmic logic programming language enabling all of the logic circuits of claim #3 as a means for enabling of the data processing system described in claim #3 above.

9. It should be understood that the following variations and modifications are intended to be included within the scope of the invention.
1. Additions or subtractions of key parameters or renaming of variable key parameters or field names, such as “Key Attributes 1”, can be made to this system without departing from the spirit and scope of the invention
2. The total number of variable headings for key parameters may be increased or decreased without departing from the spirit and scope of the invention.
3. The total number of variable headings for key parameters at all levels of hierarchy above or below any given hierarchical level, may be increased or decreased without departing from the spirit and scope of the invention.
4. The term “product” is construed to apply to any conceivable marketable item, object, service, performance, or idea. Its use includes, but is not limited to, industrial and other products, events and information such as industrial products, fish ponds, county fairs, travel information, government contracts, international trade opportunities etc.
5. Any variable field heading for any key parameter may be located using verbal, alpha, alphanumeric or numeric identifiers without departing from the spirit and scope of the invention.
6. Unique systems and methods of navigation and display will be filed in subsequent patents. However, this invention can also be navigated and displayed using the current art.
